(19) United States
(12) Patent Application Publication
(10) Pub. No.: US 2009/0253520 A1
(43) Pub. Date: Oct. 8, 2009

(54) Protective restraint system for hand-held remote control devices

(76) Inventor: Sydney Lewis-Picard, Atlanta, GA (US)

Correspondence Address: SYDNEY LEWIS-PICARD, 2733 ELKMONT RIDGE SW, ATL, GA, 30331, US

(21) Appl. No.: 12/077,521

(22) Filed: Mar. 20, 2008

Related U.S. Application Data
(60) Provisional application No. 60/921,511, filed on Apr. 3, 2007.

(51) Int. Cl. A63F 13/02

(52) U.S. Cl. 463/47; 273/148 B

(57) ABSTRACT

A protective restraint system is disclosed for a hand-held remote control device. While providing protection, the protective restraint system simultaneously allows smooth and accurate interaction with the hand-held remote control device, and protection against accidental launching of the hand-held remote control device as a projectile during use. The protective restraint system has a protective membrane that permits button interaction, and a cut-out permitting interaction with a trigger button. The protective restraint system is further adapted to allow for infrared and other communication signals to and from the hand-held remote control device while said device is in use in conjunction with said protective restraint system. Further, port connections with external devices can be made through the case without affecting the protection afforded the electronic device inside.

### CROSS-REFERENCES TO RELATED APPLICATIONS

Application No. 60/921,511

Filing or 371(c) Date: Apr. 3, 2007

CONFIRMATION NO. 1146

FILING RECEIPT: *OC000000023451401*

The applicant, Sydney Lewis-Picard, of Application No. 60/921,511 is also the applicant of this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention pertains generally to protective restraints and specifically to protective restraints for devices which serve as hand-held game controllers for video game consoles.

2. Description of the Background

The design and nature of new video game controllers has partially revolutionized video game play. The use of these controllers requires the user to imitate the ‘real world’ device represented by the hand-held controller.

For example, in playing tennis on the Nintendo® Wii®, the user must imitate the swinging of a tennis racket with the use of the hand-held controller during game play. As the ‘real life’ player swings the hand-held controller, the motion of the hand-held controller is interpreted by the main console, and the ‘computer-generated’ player within the video game instantly duplicates the motion of the hand-held controller, thereby furthering game play. A second example is, when playing golf the user must imitate the swinging of a golf club using the hand-held controller. Again, as the ‘real life’ user swings the hand-held controller, the motion of the hand-held controller is interpreted by the main console, and the ‘computer-generated’ player within the video game instantly duplicates the motion of the hand-held controller, thereby furthering game play.

During game play, users typically become excited, and subsequently over-exaggerate the range, and speed of motion of the remote controller required by the main console to adequately interpret and duplicate said motion within the game itself. This over-exaggeration of motion can lead to users accidentally dropping or throwing the controller, thus launching of the hand-held controller at high-speeds as a dangerous projectile, capable of causing damage to nearby objects such as televisions, stereo equipment, walls, windows, doors and injury to people.

### SUMMARY OF THE INVENTION

The present invention overcomes the possibility of the user dropping or throwing the controller during game play even when the user over-exaggerates the required range and speed of motion required for proper and normal game play.

The present invention may therefore comprise;
(a) a protective enclosure for the hand-held remote control device,
(b) an anchoring device to be connected to the user, and;
(c) a restraining device securing the protective enclosure to the anchoring device;
   for a hand-held remote control device comprising: a set of buttons, a port for connecting external devices, an RF or IR port, a shell which encases the internal components of said hand-held remote control device.

The invention may further comprise a method of manufacturing a protective enclosure for a hand-held remote control device comprising: a protective enclosure that is used to secure said enclosure to said restraining device, said hand-held remote control device being a separate unit from all other devices described herein, said hand-held remote control device being insertable into and removable from said protective enclosure by hand, said hand-held remote control device being substantially encased by said protective enclosure so that when said hand-held remote control device is disposed in said protective enclosure, said hand-held remote control device is sufficiently secured within the protective case with minimal risk of said hand-held remote control device inadvertently falling out of said case while in use during game play.

The invention may further comprise a method of manufacturing an anchoring device for a user comprising: providing a secure connection to the user, the anchoring device being a separate unit from other units described herein, said anchoring device being adapted to enclose the hand of the user, said hand being insertable into and removable from the anchoring device by hand.

The invention may further comprise a method of manufacturing a restraining device for a hand-held remote control device comprising: providing grip-enhancing structures to secure said restraining device to said protective enclosure, said restraining device being a separate unit from other units described herein, said restraining device being attached to and detached from the protective enclosure by hand.

The invention may further comprise a method of manufacturing a restraining device for an anchoring device comprising: providing grip-enhancing structures to secure said restraining device to said anchoring device, said restraining device being a separate unit from all other units described herein, said restraining device being attached to and detached from said anchoring device by hand.

The invention may further comprise a method of combining its elements (a), (b) and (c) into a unique system whereby together, the protective enclosure, anchoring device and restraining device simultaneously allow a user to make normal use of the hand-held remote control device during game play, and provide protection against a user accidentally launching said hand-held remote control device as a projectile at high speeds even the user over-exaggerates the range and speed of motion of the hand-held game controller required by the main console to adequately interpret and duplicate said motion within the game itself.

The forgoing description of the invention has been presentation for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the append claims be construed to include other alternative embodiments of the invention except insofar as limited by the prior art.

### BRIEF DESCRIPTION OF THE SEVERAL VIEWS OF THE DRAWING

### A. Descriptive Key

1. Transparent Membrane
2. Sleeve
3. Circumference Stitching
4. Port Stitching
5. Port Opening
6. Restraining Loop
7. Restraining Loop Connector
8. Insert Opening Flap A Stitching
9. Insert Opening Flap A
10. Insert Opening Flap Loops
11. Insert Opening Flap B Stitching
12. Insert Opening Flap B
13. Insert Opening Flap Hooks
14. Wrist Strap Opening Stitching
15. Wrist Strap Opening
16. Restraining Device
17. Restraining Device Hooks
18. Anchor Device (Glove)
19. Glove Lining
20. Glove No-slip palm
21. Glove Backhand
22. Glove Backhand Loops

### B. Description of the Drawings

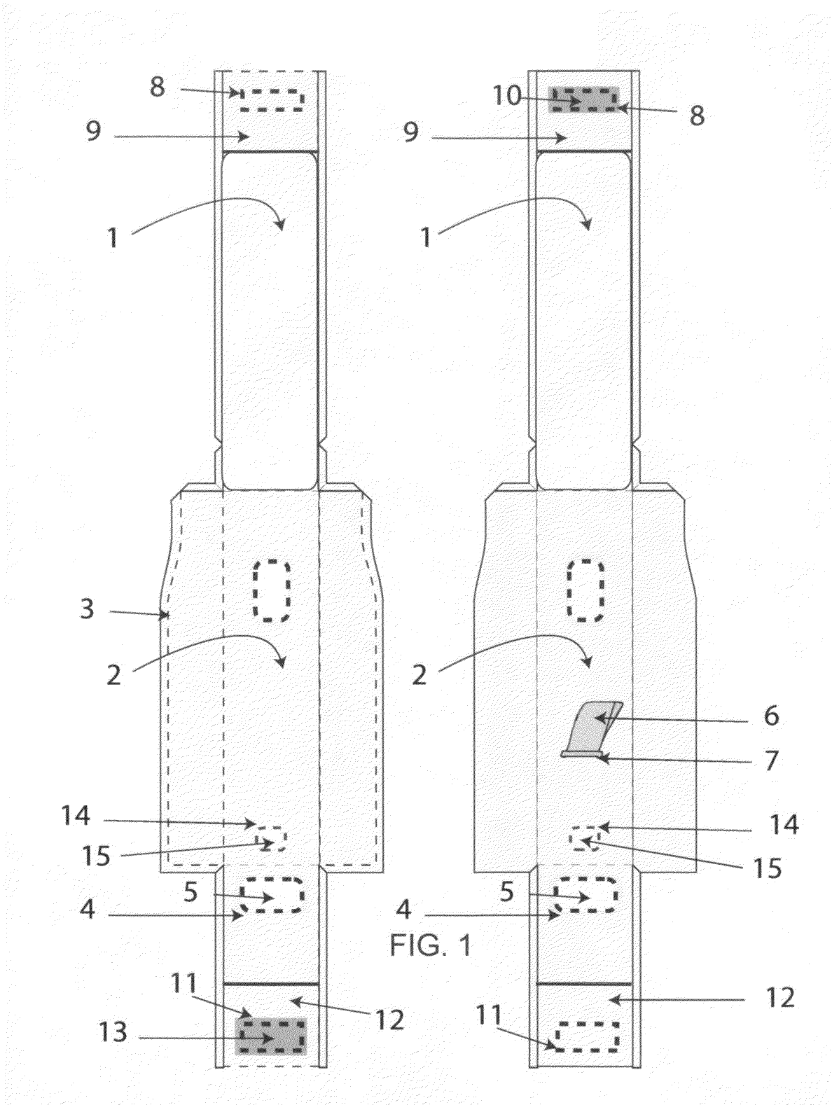

FIG. 1 is a schematic representation of the Protective Enclosure.

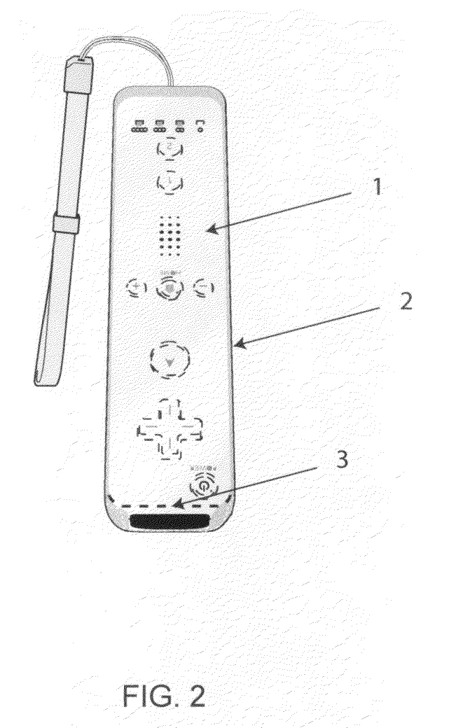

FIG. 2 shows the top front view of the game controller inserted into the Protective Enclosure, and its Transparent Membrane 1.

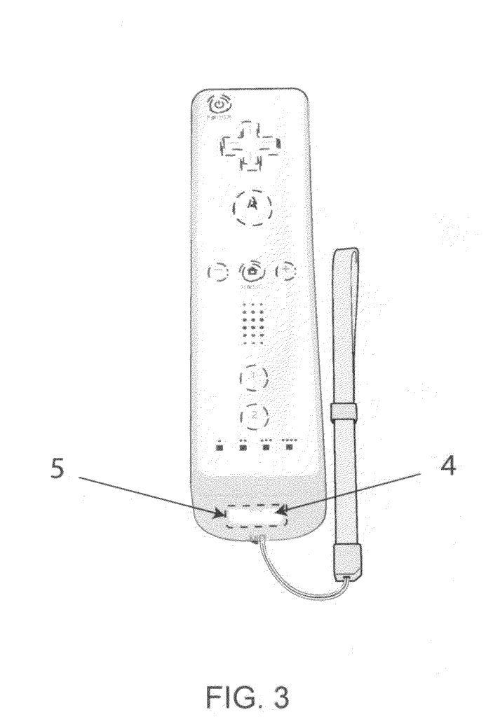

FIG. 3 shows the top rear view of the game controller inserted into the Protective Enclosure.

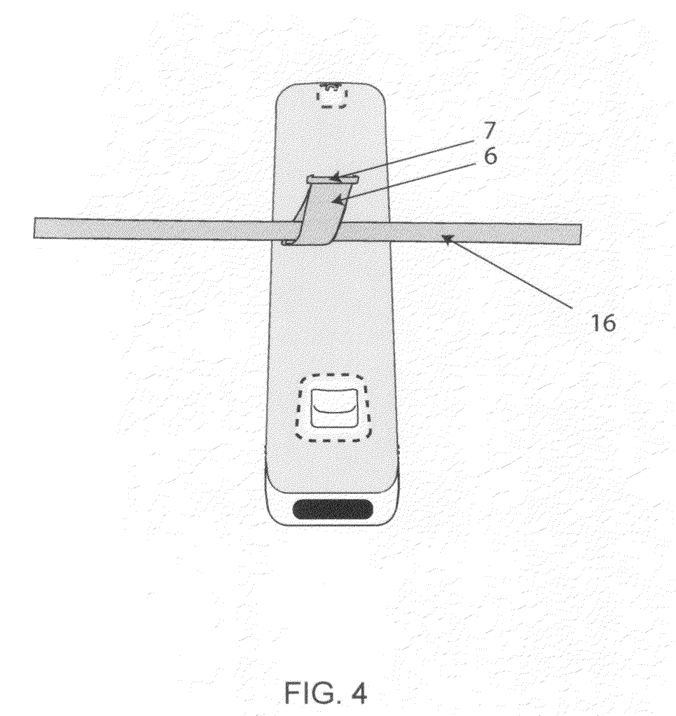

FIG. 4 shows the bottom front view of the game controller inserted into the Protective Enclosure, and the Restraining Device 16 inserted through the Restraining Loop 6.

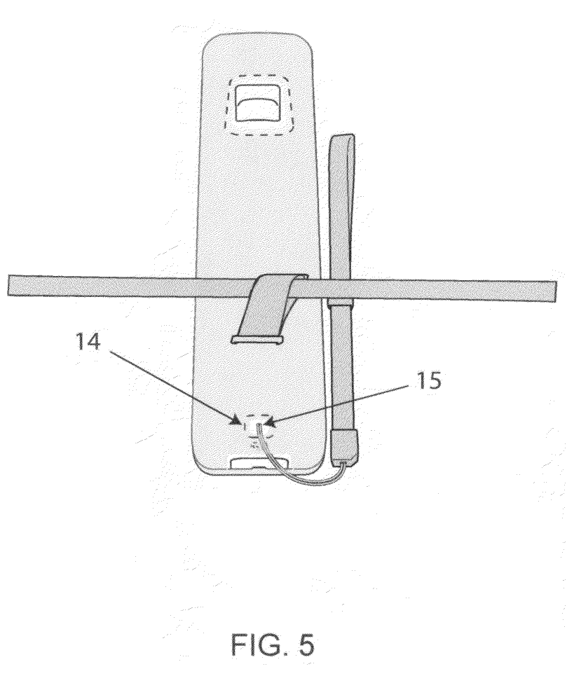

FIG. 5 shows the bottom rear view of the game controller inserted into the Protective Enclosure, revealing the Wrist Strap Opening Stitching 14, and Wrist Strap Opening 15.

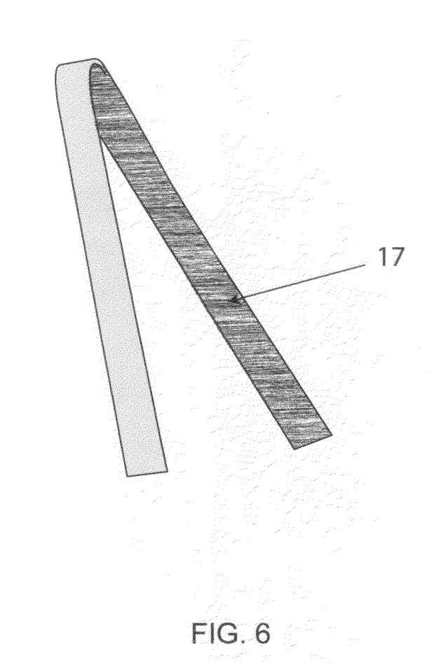

FIG. 6 shows the Restraining Device, and its ‘hooks’ 17.

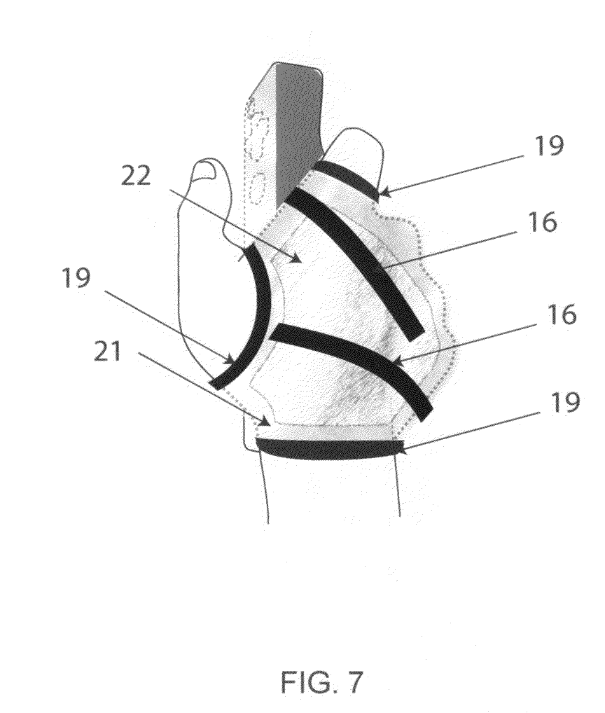

FIG. 7 shows the back-of-the-hand view of the glove, and the Restraining Device 16 secured to the Glove Backhand Loops 22 with the glove being worn, and holding the game controller.

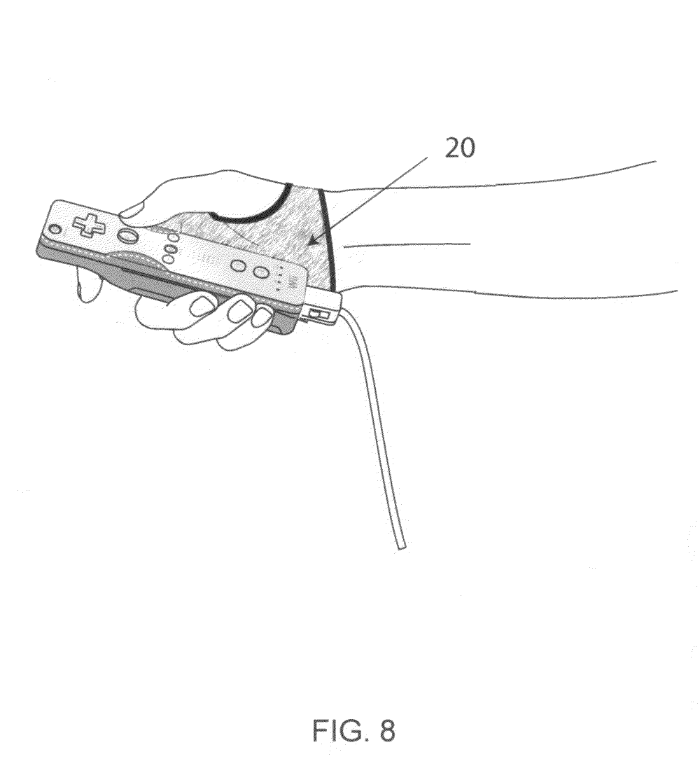

FIG. 8 shows the game controller being held in the hand, which in turn is wearing the glove, showing its No-Slip Palm Area 20.

### DETAILED DESCRIPTION OF THE INVENTION

The best mode for carrying out the invention is presented in terms of its preferred embodiment, herein depicted within the FIGS. 1 through 8.

### A. Detailed Description of the Figures

Referring now to FIG. 1, the Protective Sheath is composed of two parts, a Transparent Membrane 1 which simultaneously permits the user to see and operate the buttons of the game controller as well as permits the game controller to send and receive signals to and from the main game console; and a Sleeve 2, which further houses the game controller. In its assembly process, the Protective Sheath is folded and sewn together into the contoured shape of the game controller for a snug fit when said game controller is disposed within said Protective Sheath.

Referring now to FIG. 2, the game controller is depicted having been disposed into the Protective Sheath. The Circumference Stitching 3 is the means by which the Protective Sheath is sewn together along its length on both sides, and its front.

Referring now to FIG. 3, the game controller has as one of its features, a port for connecting additional devices. The Protective Sheath provides a Port Opening 4 to accommodate unimpeded use said port during use. The Port Opening 4 is further re-enforced with Port Stitching 5.

Referring now to FIG. 4, the Protective Sheath contains a Restraining Loop 6 which is affixed to the main body of the Sleeve by means of a Restraining Loop Connector 7. Through the Restraining Loop is inserted the Restraining Device 16.

Referring now to FIG. 5, the Protective Sheath provides a Wrist Strap Opening 15, to accommodate unimpeded use said wrist strap during use. The Wrist Strap Opening is re-enforced by means of Wrist Strap Opening Stitching 14.

Referring now to FIG. 6, the Restraining Device is a two-sided strip of material on which one side is primarily featureless, and the remaining side features the ‘hooks’ 17 portion of a ‘hooks and loops’ system.

Referring now to FIG. 7, the Anchoring Device has a Backhand Side 21, into which the majority of its surface features the ‘Loops’ 22 of a ‘hooks and loops’ system. Affixed to the ‘loops’ of the backhand side is the ‘hooks’ of the Restraining Device 16. Along the edges of the Anchoring Device the seams 19 are re-enforced along the lining by means of stitching.

Referring now to FIG. 8, the Anchoring Device functions as a glove. The palm area of the anchoring device features a non-skid material 20.

### B. Operation of the Preferred Embodiment

The three components of the Protective Restraint System, namely (a) a protective enclosure for the hand-held remote control device, (b) an anchoring device to be connected to the user, and (c) a restraining device securing the protective enclosure to the anchoring device are designed to be used in conjunction with one another. The user can assemble the system quickly and easily with little or no training.

Before inserting the game controller inside the Protective Sheath, the user, at his or her discretion connect the wrist strap to the game controller according to the instructions given by the manufacturer. The user will insert the game controller inside the Protective Sheath and secure said controller therein by pressing the ‘hooks’ of Flap A to the ‘loops’ of Flap B.

The user is required to wear said Anchoring Device as he or she would wear a glove. Once the user is wearing the anchoring device on the desired hand, he or she should run the Restraining Device through the Restraining Loop at the bottom of the Protective Sheath taking care to position the ‘loops’ side of the Restraining Device away from the body of the Protective Sheath.

Next, the user should place the game controller in the desired hand in which the Anchoring Device is being worn so that it is in a comfortable position and the user is able to comfortably reach all buttons. Next, the user should wrap each side of the Restraining Device around the hand over to the Backhand Side, and press end of the ‘hooks’ sides of said Restraining Device to the ‘loops’ area of the Backhand side. At this point, the game controller should fit comfortably in the desired hand permitting the user to access all buttons and view all displays of the game controller.

Now, the user may play games using the game controller without fear of accidentally launching the game controller as a projectile during game play.

What is claimed is:

1. A protective restraint system comprising:
(a) a protective enclosure for the hand-held remote control device,
(b) an anchoring device to be connected to the user, and;
(c) a restraining device securing the protective enclosure to the anchoring device;
for a hand-held remote control device comprising: a set of buttons, a port for connecting external devices, a Radio Frequency (RF) or Infra Red (IR) port, a shell which encases the internal components of said hand-held remote control device, said hand-held remote control device being a separate unit from other devices described herein, said hand-held remote control device being insertable into and removable from said protective enclosure by hand, said shell being substantially encased by said protective enclosure so that when said hand-held remote control device is disposed in said protective enclosure in conjunction with said anchoring devise and said restraining devise, said shell is secured against accidental dropping, throwing, or otherwise discharge as a projectile by the user during use.

2. The protective restraint system of claim 1 wherein the protective enclosure further comprises grip-enhancing structures that enable said protective enclosure to be secured to said restraining device during use of said hand-held remote control device in conjunction with the complete protective restraint system.

3. The anchoring device of claim 1 wherein the anchoring device uses at least one restraint to further secure said anchor to the user during use of said hand-held remote control device in conjunction with the complete protective restraint system.

4. The restraining device claim of 1 wherein the restraining device further comprises grip-enhancing structures that enable said protective enclosure to be secured to said anchoring device during use of said hand-held remote control device in conjunction with the complete protective restraint system.
